(19) United States
(12) Patent Application Publication
(10) Pub. No.: US 2025/0068929 A1
(43) Pub. Date: Feb. 27, 2025

(54) METHOD AND APPARATUS FOR INFORMATION FUSION, METHOD AND APPARATUS FOR DATA COMMUNICATION, AND ELECTRONIC DEVICE AND NON-TRANSITORY READABLE STORAGE MEDIUM

(71) Applicant: IEIT SYSTEMS CO., LTD., Jinan, Shandong (CN)

(72) Inventors: Ruidong YAN, Jinan, Shandong (CN); Zhenhua GUO, Jinan, Shandong (CN); Yaqian ZHAO, Jinan, Shandong (CN); Zhiyong QIU, Jinan, Shandong (CN)

(73) Assignee: IEIT SYSTEMS CO., LTD., Jinan, Shandong (CN)

(21) Appl. No.: 18/724,532

(22) PCT Filed: Nov. 23, 2023
(86) PCT No.: PCT/CN2022/133806

§ 371 Date: Jun. 26, 2024

(30) Foreign Application Priority Data
Jul. 18, 2022 (CN) 202210838709.3

(51) Int. Cl. G06N 3/098

(52) U.S. Cl. CPC G06N 3/098

(57) ABSTRACT

The embodiments of the present disclosure relate to the technical field of computers. Disclosed are a method and apparatus for information fusion, a method and apparatus for data communication, and an electronic device and a non-transitory computer-readable storage medium. The method for information fusion includes: in response to that a communication triggering condition is met, acquiring a local parameter of each of workers in a distributed training system, where the communication triggering condition is that all key nodes complete tasks of the current round of training; selecting N key nodes participating in the next round of training, and fusing local parameters of the N key nodes to obtain a global parameter; and sending the global parameter to each of the workers, and sending a training command to the key nodes to the key nodes execute tasks of next round of training based on the global parameter.

### CROSS-REFERENCE TO RELATED APPLICATION

The present application is a National Stage Application of PCT International Application No.: PCT/CN2022/133806 filed on Nov. 23, 2022, which claims priority to Chinese Patent Application 202210838709.3, filed in the China National Intellectual Property Administration on Jul. 18, 2022, the disclosure of which is incorporated herein by reference in its entirety.

### TECHNICAL FIELD

The present disclosure relates to the technical field of computers, and more specifically, to a method and apparatus for information fusion, a method and apparatus for data communication, and an electronic device and a non-transitory readable storage medium.

### BACKGROUND

Although relevant methods and algorithms have deep learning model training communication problems, the methods and algorithms suffer from the following shortcomings: the algorithmic logic is complex and intensive computation makes the algorithm performance limited. Effective solutions of the deep learning problems generally rely on the support of big data sets and large models. However, it has been demonstrated that inefficient communication methods take at least weeks to train neural network models and are thus difficult to apply for time-sensitive task scenarios.

### SUMMARY

The embodiments of the present disclosure provide a method for information fusion, which is applied to a server in a distributed training system and including the following operations:
in response to that a communication triggering condition is met, a local parameter of each of workers in a distributed training system is acquired, where the communication triggering condition is that all key nodes participating in the current round of training complete tasks of the current round of training.

N key nodes participating in the next round of training are selected from each of the workers, and local parameters of the N key nodes are fused to obtain a global parameter.

The global parameter is sent to each of the workers, and a training command is sent to the key nodes to the key nodes execute tasks of the next round of training based on the global parameter.

In some embodiments, all the key nodes participating in the current round of training complete the tasks of the current round of training includes the following operation:
all the key nodes participating in the current round of training complete a preset number of iterative training processes.

In some embodiments, the N key nodes are selected from each of the workers participating in the next round of training includes the following operation:
an average parameter of the local parameters of the key nodes is calculated, a deviation of the local parameter of each of the workers from the average parameter is determined, and N workers with the minimum deviation are selected as the key nodes participating in the next round of training.

In some embodiments, the deviation of the local parameter of each of the workers from the average parameter is determined includes the following operation:
the average parameter is sent to each of the workers to calculate the deviation of local parameter of each of the workers from the average parameter, and the deviation of local parameter of each of the workers from the average parameter is returned to the server.

In some embodiments, the method further includes the following operation:
a training model is divided into a plurality of training sub-models, and the training sub-models are assigned to each of the workers.

In some embodiments, the training model is divided into the plurality of training sub-models includes the following operation:
the training model is divided into the plurality of training sub-models in a horizontal direction or a vertical direction.

In some embodiments, the method further includes the following operation:
a plurality of training samples are assigned to each of the workers to each of the workers executes an iterative training process based on the corresponding training samples.

In some embodiments, the plurality of training samples are assigned to each of the workers includes the following operation:
the plurality of training samples are assigned to each of the workers based on a sampling method, or the plurality of training samples are split according to a data dimension, and assigned to each of the workers.

In some embodiments, the plurality of training samples are assigned to each of the workers based on the sampling method includes: the plurality of training samples are assigned to each of the workers by means of put-back random sampling and/or local scrambling sampling; or assigning the plurality of training samples to each of the workers by means of put-back random sampling and/or global scrambling sampling.

In some embodiments, the plurality of training samples are split according to the data dimension, and split training samples are assigned to each of the workers includes: in response to that each training sample has a multi-dimensional attribute or feature, the plurality of training samples are split according to different attributes, and split sample subsets are assigned to the corresponding workers.

In some embodiments, fusing the local parameters of the N key nodes to obtain the global parameter includes: calculating an average value of the local parameters of the N key nodes, and determining the average value as the global parameter.

The embodiments of the present disclosure provide a method for data communication, which is applied to a worker in a distributed training system and including the following operations:

In response to that a communication triggering condition is met, a compression operation is performed on local parameters of each of the workers based on a preset compression algorithm, and the compressed local parameters are transmitted to a server.

A global parameter sent by the server is acquired, where the global parameter is obtained by fusing, by the server, local parameters of N key nodes.

In response to that receiving a training command sent by the server, corresponding training tasks are executed based on the global parameter.

The preset compression algorithm is as follows:

$$C [ x ] = λ \cdot \frac{{‖ x ‖}_{2}}{d} \cdot sign ( x ) ;$$

wherein x is the local parameter, is a ∥x∥₂ norm of x, sign(x) is the sign of x, d is a dimension of the local parameter, λ=|Σᵢ₌₁^{d}xᵢ|/d, xᵢ is an i-th dimension of x, and C[x] is the compressed local parameter.

The method further includes the following operation:
an average parameter sent by the server is acquired, and a deviation of local parameters of each of the workers from the average parameter is calculated, and returned to the server.

In response to that the communication triggering condition is met, performing the compression operation on local parameters of each of the workers based on the preset compression algorithm, and transmitting the compressed local parameters to the server includes: in response to that the key nodes participating in the current round of training complete tasks of the current round of training, performing the compression operation on local parameters of each of the workers based on the preset compression algorithm, and transmitting the compressed local parameters to the server. Acquiring the global parameter sent by the server includes: in response to that the worker is selected as the key nodes participating in the next round of training, acquiring the global parameter sent by the server. In response to that receiving the training command sent by the server, the corresponding training tasks are executed based on the global parameter includes: when receiving the training command sent by the server, executing tasks of the next round of training based on the global parameter.

The method further includes: acquiring part of a plurality of training sub-models, wherein the plurality of training sub-models are sub-models that are obtained by dividing a training model associated with the training tasks, and the plurality of training sub-models are assigned to each of the workers in the distributed training system; and/or acquiring part of a plurality of training samples, wherein the plurality of training samples are training samples associated with the training tasks, the plurality of training samples are assigned to each of the workers, and each of the workers is used for executing an iterative training process based on the corresponding training samples.

The embodiments of the present disclosure provide an apparatus for information fusion, which is applied to a server in a distributed training system and including a first acquisition module, a fusion module, and a sending module.

The first acquisition module is configured to, in response to that a communication triggering condition is met, acquire a local parameter of each of workers in a distributed training system. The communication triggering condition is that all key nodes participating in the current round of training complete tasks of the current round of training.

The fusion module is configured to select, from each of the workers, N key nodes participating in the next round of training, and fuse local parameters of the N key nodes to obtain a global parameter.

The sending module is configured to send the global parameter to each of the workers, and send a training command to the key nodes to the key nodes execute tasks of the next round of training based on the global parameter.

The embodiments of the present disclosure provide an apparatus for data communication, which is applied to a worker in a distributed training system and including a compression module, a second acquisition module, and an execution module.

The compression module is configured to, in response to that a communication triggering condition is met, perform a compression operation on local parameters of each of the workers based on a preset compression algorithm, and transmit the compressed local parameters to a server.

The second acquisition module is configured to acquire a global parameter sent by the server. The global parameter is obtained by fusing, by the server, local parameters of N key nodes.

The execution module is configured to, in response to that receiving a training command sent by the server, execute corresponding training tasks based on the global parameter.

The embodiments of the present disclosure provide an electronic device, including a memory and a processor.

The memory is configured to store a computer program.

The processor is configured to implement, when the computer program is executed, steps of the method for information fusion or the method for data communication as described above.

The embodiments of the present disclosure provide a non-transitory computer-readable storage medium. The non-transitory computer-readable storage medium stores a computer program. When the computer program is executed by a processor, steps of the method for information fusion or the method for data communication as described above are implemented local parameters of each of the workers

The embodiments of the present disclosure further disclose an apparatus for information fusion, an apparatus for data communication, and an electronic device and a non-transitory readable storage medium.

It is to be understood that, the above general description and the following detailed description are merely exemplary, and cannot limit the embodiments of the present disclosure.

### BRIEF DESCRIPTION OF THE DRAWINGS

In order to more clearly illustrate the embodiments of the present disclosure or the technical solutions in the related art, the drawings used in the description of the embodiments or the related art will be briefly described below. It is apparent that the drawings in the following descriptions are merely some embodiments of the present disclosure. Other drawings may also be obtained from those skilled in the art according to these drawings without any creative work. The drawings are used to provide an understanding of the present disclosure, and constitute a part of the specification, which are used to explain the present disclosure with the optional implementations below, and do not constitute a limitation of the present disclosure. In the drawings:

FIG. 1 is a schematic diagram of a centralized architecture and a decentralized architecture.

FIG. 2 is an architecture diagram of information fusion of distributed nodes facing a parameter server architecture according to an exemplary embodiment.

FIG. 3 is a flowchart of a method for information fusion according to an exemplary embodiment.

FIG. 4 is a flowchart of a method for data communication according to an exemplary embodiment.

FIG. 5 is a structural diagram of an apparatus for information fusion according to an exemplary embodiment.

FIG. 6 is a structural diagram of an apparatus for data communication according to an exemplary embodiment.

FIG. 7 is a structural diagram of an electronic device according to an exemplary embodiment.

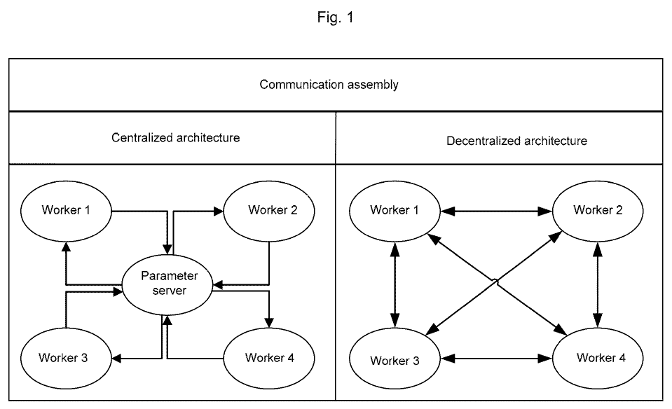

### DETAILED DESCRIPTION OF THE EMBODIMENTS

The technical solutions in the embodiments of the present disclosure are clearly and completely described below with reference to the drawings in the embodiments of the present disclosure. It is apparent that the described embodiments are only part of the embodiments of the present disclosure, not all the embodiments. All other embodiments obtained by those of ordinary skill in the art on the basis of the embodiments in the present disclosure without creative work all fall within the scope of protection of the embodiments of the present disclosure. In addition, in the embodiments of the present disclosure, terms “first”, “second” and the like are used for distinguishing similar objects rather than describing a specific sequence or a precedence order.

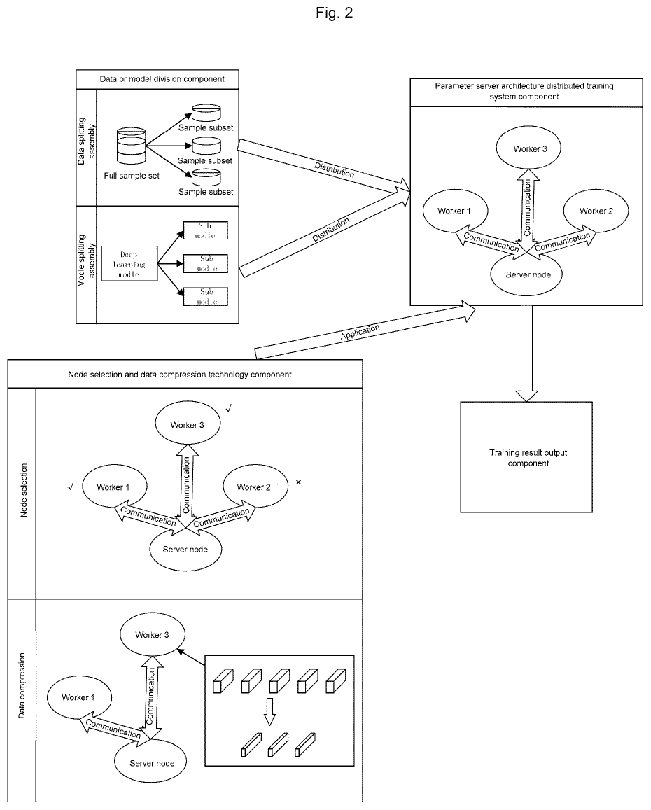

An architecture diagram of information fusion of distributed nodes facing a parameter server architecture provided in the embodiments of the present disclosure is shown in FIG. 2, including a data/model division component, a parameter server architecture distributed training system component, a node selection and data compression technology component, and a training result output component.

The data/model division component mainly completes a task of inputting a data set and model to be processed. A data splitting module is mainly responsible for performing a splitting task on the data sets, and deploying split sub data sets onto corresponding workers; and a model splitting module is mainly responsible for splitting an original large model into a plurality of small sub models.

The parameter server architecture distributed training system component is mainly configured to complete actual training tasks.

The node selection and data compression technology component acts as a core technology of an entire distributed training system architecture. A node selection module completes a task of selecting key workers, and circumvents the computation of information about all workers, so as to effectively relieve the problem of “communication bottlenecks” of a parameter server; and a data compression module compresses communication traffic from a data perspective, so as to accelerate the speed of model training. For example, an original distributed training system in FIG. 2 includes a worker 1, a worker 2, a worker 3, and a parameter server node. By means of a selection method designed by the node selection module, the ineligible worker 2 is eliminated. Therefore, only the worker 1, the worker 3, and the parameter server node actually participate in computation in subsequent iteration processes. In addition, a data compression technology is used for communication information (such as gradient and model parameters) of the worker 1 and the worker 3, respectively, so as to reduce the communication traffic. A parameter server architecture mainly has two roles of workers and servers. The worker is mainly responsible for: first, completing local training tasks based on local data samples; and secondly, communicating with the server through a client interface. The server is mainly responsible for: first, combining or fusing a local gradient sent by each of the workers; and secondly, updating a global model parameter and returning global model parameter to each of the workers.

The training result output component is responsible for outputting a global solution of the training tasks, and displaying same in a visual manner for subsequent improvement and optimization.

To sum up, each component has its own role and works in tandem to complete all types of complex training tasks.

The embodiments of the present disclosure disclose a method for information fusion, so as to accelerate the speed of distributed training of a model.

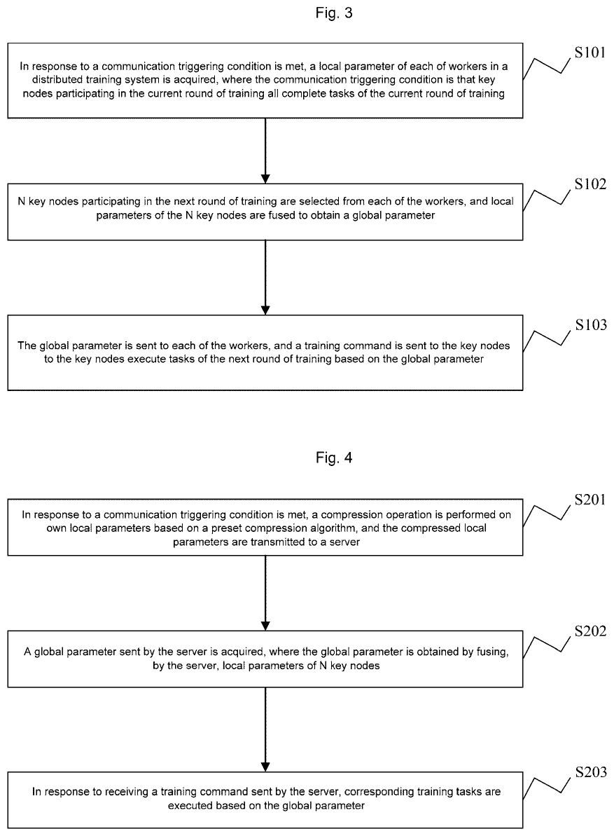

FIG. 3 is a flowchart of a method for information fusion according to an exemplary embodiment. As shown in FIG. 3, the method includes the following steps.

At S101, in response to that a communication triggering condition is met, a local parameter of each of workers in a distributed training system is acquired, where the communication triggering condition is that all key nodes participating in the current round of training complete tasks of the current round of training.

This embodiment is applied to the distributed training system. The distributed training system includes a plurality of workers and one center worker (server). Each worker is connected to the server in a two-way manner, indicating that data transmission may be bi-directional. However, there is no direct connection between the workers. Each worker may use a global parameter provided by the server to independently perform respective training tasks. In detail, each worker communicates with the server through the following two operations. The first operation is PULL, i.e. the worker acquires the global parameter from the server; and the second operation is PUSH, i.e. the worker sends the local parameter to the server. In this embodiment, an execution subject is the server.

In some embodiments, the workers send the respective local parameters \hat{x}ₜ₊₁^{r} to the server, and in response to that all the key nodes participating in the current round of training complete the tasks of the current round of training, the server may acquire the local parameter of each of the workers. The key nodes are N nodes participating in training that are selected in all the workers by the server before the current round of training is executed, wherein N=1 or N=2, or N is a positive integer greater than or equal to 3. In some embodiments, the N nodes participating in training may be part of the workers. In the embodiments of the present disclosure, the communication triggering condition may be that all the key nodes participating in the current round of training complete a preset number of iterative training processes. In this embodiment, the preset number is not limited. For example, if the preset number is 1, at the completion of each iteration, the worker and the server perform local parameter synchronization; if the preset number is 10, after each of the workers completes iteration for 10 times respectively, and the worker then performs local parameter synchronization with the server; and if the preset number is T (the total number of iterations), after each of the workers completes all iterations, the worker finally performs local parameter synchronization with the server.

At S102, N key nodes participating in the next round of training are selected from each of the workers, and local parameters of the N key nodes are fused to obtain a global parameter.

In this step, N key nodes are re-selected for the next round of training, and the local parameters of the N key nodes are fused to obtain the global parameter, that is, an average value of the local parameters of the N key nodes is calculated as the global parameter.

In some embodiments, selecting, from each of the workers, the N key nodes participating in the next round of training includes: calculating an average parameter of the local parameters of the key nodes, determining a deviation of the local parameter of each of the workers from the average parameter, and selecting N workers with the minimum deviation as the key nodes participating in the next round of training. In some embodiments, the N workers selected may be part of the workers described above.

In some embodiments, the server calculates one average parameter x̅ₜ=1/n (Σᵣ₌₁ⁿ\hat{x}ₜ₊₁^{r}); the deviation between the local parameter of a r-th worker and the average parameter is determined: |x̅ₜ₊₁^{r}−x̅ₜ|=vᵣ; and v₁, v₂, . . . , vᵣ, . . . , and vₙ are arranged in a sequence from large to small, and N small workers are selected as the key nodes.

In some embodiments, determining the deviation of the local parameter of each of the workers from the average parameter includes: sending the average parameter to each of the workers such that each of the workers calculates the deviation of local parameter of each of the workers from the average parameter, and returning the deviation of local parameter of each of the workers from the average parameter to the server.

In some embodiments, the server returns the average parameter obtained through calculation to each of the workers, and each of the workers calculates the deviation of local parameter of each of the workers from the average parameter, and returns the deviation of local parameter of each of the workers from the average parameter to the server.

At S103, the global parameter is sent to each of the workers, and a training command is sent to the key nodes such that the key nodes execute tasks of the next round of training based on the global parameter.

In this step, the server sends the global parameter to each of the workers, and the workers update local parameters of each of the workers to the global parameter. However, only the key nodes execute the tasks of the next round of training, and other workers that are not selected as the key nodes do not execute the tasks of the next round of training, such that the speed of distributed training of a model is accelerated.

An input of a distributed node information fusion algorithm facing the parameter server architecture includes: the total number T of iterations, a learning rate η, an initial model parameter x0, an iterative communication triggering condition σ, and the number N of key nodes; and an output includes a global convergence model parameter xT. An execution process includes the following:
for the number of iterations t=0, 1, . . . , T do
each worker executes a worker training function Worker_Training(t) in parallel;
if the number t of iterations meets the communication triggering condition σ do the server executes a server node training function Server_Training(t);
end if
end for
Return global convergence model parameter xT

The worker training function Worker_Training(t) may be defined as:
Function Worker_Training(t)
Assuming that the r-th worker executes random sampling once and acquires one training sample ξₜ^{(r)};
the worker pulls a newest global parameter x from the server;
based on the parameter x and the training sample ξₜ^{(r)}, a local random gradient gₜ^{(r)}=∇fᵣ(x, ξₜ^{(r)}) is calculated;
the worker updates the local parameter xₜ₊₁^{r}=xₜ^{r}−η*gₜ^{(r)};
the worker calls a gradient compression function Compress_gradient( ) to convert xₜ₊₁^{r} into \hat{x}ₜ₊₁^{r};
the worker pushes xₜ₊₁^{r} to the server;
end Function

The server node training function Server_Training(t) is defined as follows:
Function Server_Training(t)
A worker selection function Worker_Selction( ) is called to select N key nodes for global parameter information fusion and synchronization;
global model parameter information fusion is calculated:

$$X = \frac{1}{N} {\sum }_{r = 1}^{N} {\hat{x}}_{t + 1}^{r} ;$$

the server sends the global parameter to each of the workers;
end Function

According to the method for information fusion provided in the embodiments of the present disclosure, the server only selects N key nodes for information fusion, such that the number of the fused workers is effectively reduced. And N key nodes are only selected in the next round of training to execute the training tasks, and other workers do not execute the training tasks, such that the speed of distributed training of a model is accelerated.

It may be understood that, two necessary prerequisites for a deep learning model training task lie in data and models. Training a deep learning model relies on quality data sets. The data/model division component is responsible for using a data set and model to be processed as an input of the deep learning model training task, and providing an interface for users to access the data or models.

Generally, the input deep learning model/data set is difficult to process due to a huge scale. Therefore, by using the divide and rule thought, an original large-scale data set or model is decomposed to make a processing process relatively easy. The component includes the data splitting module (also referred to as data parallelism) and a model splitting module (also referred to as module parallelism).

On the basis of the above embodiments, the method further includes: dividing a training model into a plurality of training sub-models, and assigning the training sub-models to each of the workers.

In some embodiments, if a training task model is too large and cannot be stored in a stand-alone manner, the model needs to be effectively split to make the training tasks feasible. The module parallelism splits a model parameter into a plurality of sub-models, and each of the sub-models is assigned to different workers. It is to be noted that, due to the particularity of a neural network model, i.e. a layered structure of the neural network model, the neural network model has significant advantages in terms of application model parallelism. The neural network model may be horizontally split or vertically split according to different splitting methods, that is, dividing the training model into the plurality of training sub-models includes: dividing the training model into the plurality of training sub-models in a horizontal direction or a vertical direction.

On the basis of the above embodiments, the method further includes: assigning a plurality of training samples to each of the workers such that each of the workers executes an iterative training process based on the corresponding training samples.

The data parallelism relies on a plurality of processors (workers) to segment the data sets to realize segmentation calculation in a parallel computing environment. A data parallelism algorithm focuses on distributing data onto different parallel workers, and each of the workers executes the same computing model. A data parallelism mode is classified into sample-based data parallelism and sample dimension-based data parallelism according to different splitting strategies of the data sets. That is, assigning the plurality of samples to each of the workers includes: assigning the plurality of training samples to each of the workers based on a sampling method, or splitting the plurality of training samples according to a data dimension, and assigning split training samples to each of the workers. The sample-based data parallelism: assuming that a distributed training system data set includes a plurality of data samples and a plurality of workers, the samples are assigned to the plurality of workers by means of put-back random sampling and/or local (global) scrambling sampling. The sample dimension-based data parallelism: assuming that the data set includes a plurality of samples and each sample has a multi-dimensional attribute or feature, the distributed training system includes the plurality of workers, from a sample attribute dimension, the plurality of samples are split according to different attributes, and split sample subsets are assigned to the corresponding workers.

In addition, the model splitting module and the data splitting module are used at the same time in some scenarios, such that a hybrid splitting strategy for the data and models is generated. The hybrid splitting strategy (hybrid parallelism) for the data and models, as the name suggests, is to combine the data parallelism mode and the model parallelism mode at the same time. On one hand, the data set is split, and on the other hand, the mode is also split, such that the hybrid splitting strategy can be applied to more complex model training tasks.

The embodiments of the present disclosure disclose a method for data communication, so as to reduce communication overheads between the server and the worker.

FIG. 4 is a flowchart of a method for data communication according to an exemplary embodiment. As shown in FIG. 4, the method includes the following steps.

At S201, in response to that a communication triggering condition is met, a compression operation is performed on local parameters of each of the workers based on a preset compression algorithm, and the compressed local parameters are transmitted to a server.

An execution subject of this embodiment is the worker in the distributed training system. In some embodiments, the worker needs to transmit local parameter of each of the workers to the server.

In a real deep neural network model training scenario, it has been shown that gradient computation or communication accounts for more than 94% of the total duration of GPU training, severely limiting training efficiency. In order to reduce communication traffic, an improved 1-bit compression technology is used. An original 1-bit compression technology is defined as follows:

Allowing C[*] to indicate a compression operation, |⋅|₁ to represent a L1 norm of a found vector, x∈Rd to represent one d-dimensional real number vector, and sign (x) to represent the sign of a taken vector x, the 1-bit compression operation is performed on the vector x:

$$C [ x ] = \frac{{‖ x ‖}_{1}}{d} \cdot sign ( x ) ;$$

Although the communication traffic can be reduced in the above compression process, error codes are produced in some situations. For example, for the vector x=[1, −2, 3] and a vector y=[1, 2, 3],

$$C [ x ] = ( \vert 1 \vert + \vert - 2 \vert + \vert 3 \vert ) / 3 * ( + ) ;$$

$$C [ y ] = ( \vert 1 \vert + \vert 2 \vert + \vert 3 \vert ) / 3 * ( + ) ;$$

Compression results of the two vectors are the same. In other words, different vectors after original 1-bit compression have the same result, it is apparent that such compression produces error codes. On the contrary, the results of compression should be as differentiated as possible for different vectors. For this purpose, in this embodiment, the improved 1-bit compression technology is designed to circumvent the above problems. The improved 1-bit compression technology (i.e. preset compression algorithm) is shown as follows:

$$C [ x ] = λ \cdot \frac{{‖ x ‖}_{2}}{d} \cdot sign ( x ) ;$$

where x is the local parameter, ∥x∥₂ is a L2 norm of x, sign(x) is the sign of x, d is a dimension of the local parameter, λ=|Σᵢ₌₁^{d}xᵢ|/d, xᵢ is an i-th dimension of x, and C[x] is the compressed local parameter.

The improved solution differs from the original solution in two main ways: one is to use a λ coefficient to circumvent the error code problem, and the other is to use the L2 norm to replace the original L1 norm, this is because the mathematical property of the L2 norm is better. It may be seen that, by means of the preset compression algorithm, 32 bits of original training data or 16 bits of data may be compressed to 1 bit, such that communication overheads between the server and the worker is reduced.

In this embodiment, the method further includes: acquiring an average parameter sent by the server, calculating a deviation of local parameters of each of the workers from the average parameter, and returning same to the server.

At S202, a global parameter sent by the server is acquired, where the global parameter is obtained by fusing, by the server, local parameters of N key nodes.

At S203, in response to that receiving a training command sent by the server, corresponding training tasks are executed based on the global parameter.

According to the method for data communication provided in the embodiments of the present disclosure, before transmitting local parameters of each of the workers to the server, the workers compress the local parameters based on the preset compression algorithm, such that communication traffic between the server and the worker is reduced, thereby reducing communication overheads between the server and the worker.

An information fusion apparatus provided in the embodiments of the present disclosure is introduced below. The information fusion apparatus described below and the method for information fusion described above may be used as cross references for each other.

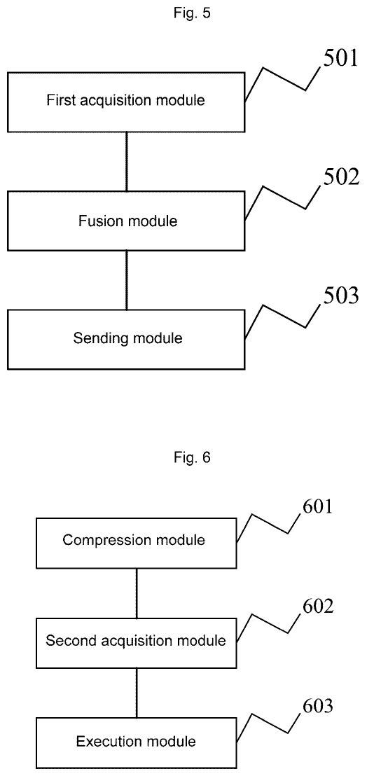

FIG. 5 is a structural diagram of an information fusion apparatus according to an exemplary embodiment. As shown in FIG. 5, the apparatus includes a first acquisition module, a fusion module, and a sending module.

The first acquisition module 501 is configured to, in response to that a communication triggering condition is met, acquire a local parameter of each of workers in a distributed training system. The communication triggering condition is that all key nodes participating in the current round of training complete tasks of the current round of training.

The fusion module 502 is configured to select, from each of the workers, N key nodes participating in the next round of training, and fuse local parameters of the N key nodes to obtain a global parameter.

The sending module 503 is configured to send the global parameter to each of the workers, and send a training command to the key nodes such that the key nodes execute tasks of the next round of training based on the global parameter.

According to the information fusion apparatus provided in the embodiments of the present disclosure, the server only selects N key nodes for information fusion, such that the number of the fused workers is effectively reduced; and N key nodes are only selected in the next round of training to execute the training tasks, and other workers do not execute the training tasks, such that the speed of distributed training of a model is accelerated.

On the basis of the above embodiments, the communication triggering condition is that all the key nodes participating in the current round of training complete a preset number of iterative training processes.

On the basis of the above embodiments, the fusion module 502 includes a selection unit and a fusion unit.

The selection unit is configured to calculate an average parameter of the local parameters of the key nodes, determine a deviation of the local parameter of each of the workers from the average parameter, and select N workers with the minimum deviation as the key nodes participating in the next round of training.

The fusion unit is configured to fuse the local parameters of the N key nodes to obtain the global parameter.

On the basis of the above embodiments, the selection unit is configured to: calculate an average parameter of the local parameters of the key nodes, send the average parameter to each of the workers such that each of the workers calculates the deviation of local parameter of each of the workers from the average parameter, and return the deviation of local parameter of each of the workers from the average parameter to the server; and select N workers with the minimum deviation as the key nodes participating in the next round of training.

On the basis of the above embodiments, the apparatus further includes a first assignment module.

The first assignment module is configured to divide a training model into a plurality of training sub-models, and assign the training sub-models to each of the workers.

On the basis of the above embodiments, the first assignment module is configured to: divide the training model into the plurality of training sub-models in a horizontal direction or a vertical direction, and assign the training sub-models to each of the workers.

On the basis of the above embodiments, the apparatus further includes a second assignment module.

The second assignment module is configured to assign a plurality of training samples to each of the workers such that each of the workers executes an iterative training process based on the corresponding training samples.

On the basis of the above embodiments, the second assignment module is configured to: assign the plurality of training samples to each of the workers based on a sampling method, or split the plurality of training samples according to a data dimension, and assign split training samples to each of the workers.

A data communication apparatus provided in the embodiments of the present disclosure is introduced below. The data communication apparatus described below and the method for data communication described above may be used as cross references for each other.

FIG. 6 is a structural diagram of a data communication apparatus according to an exemplary embodiment. As shown in FIG. 6, the apparatus includes a compression module, a second acquisition module, and an execution module.

The compression module 601 is configured to, in response to that a communication triggering condition is met, perform a compression operation on local parameters of each of the workers based on a preset compression algorithm, and transmit the compressed local parameters to a server.

The second acquisition module 602 is configured to acquire a global parameter sent by the server. The global parameter is obtained by fusing, by the server, local parameters of N key nodes. The execution module 603 is configured to, in response to that receiving a training command sent by the server, execute corresponding training tasks based on the global parameter.

According to the data communication apparatus provided in the embodiments of the present disclosure, before transmitting local parameters of each of the workers to the server, the workers compress the local parameters based on the preset compression algorithm, such that communication traffic between the server and the worker is reduced, thereby reducing communication overheads between the server and the worker.

On the basis of the above embodiments, the preset compression algorithm is shown as follows:

$$C [ x ] = λ \cdot \frac{{‖ x ‖}_{2}}{d} \cdot sign ( x ) ;$$

where x is the local parameter, ∥x∥₂ is a L2 norm of x, sign(x) is the sign of x, d is a dimension of the local parameter, λ=|Σᵢ₌₁^{d}xᵢ|/d, xᵢ is an i-th dimension of x, and C[x] is the compressed local parameter.

On the basis of the above embodiments, the apparatus further includes a calculation module.

The calculation module is configured to acquire an average parameter sent by the server, calculate a deviation of local parameters of each of the workers from the average parameter, and return the deviation of local parameters of each of the workers from the average parameter to the server.

For the apparatus in the above embodiments, the optional manner in which each module performs operations has been described in detail in the embodiments of the method, and details are not described herein again.

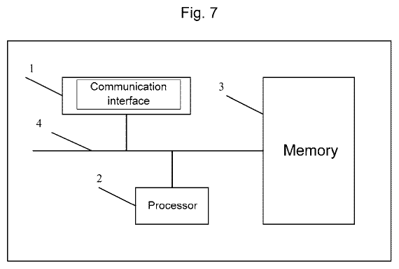

On the basis of hardware implementation of the above program modules, and in order to implement the method in the embodiments of the present disclosure, an embodiment of the present disclosure further provides an electronic device. FIG. 7 is a structural diagram of an electronic device according to an exemplary embodiment. As shown in FIG. 7, the electronic device includes a communication interface and a processor.

The communication interface 1 can communicate with other devices, such as a network device.

The processor 2 is connected to the communication interface 1, and is configured to execute, in response to that running a computer program, the method for information fusion or the method for data communication provided by the one or more technical solutions. The computer program is stored on the memory 3.

Definitely, during a practical application, each assembly in the electronic device is coupled together by means of a bus system 4. It may be understood that, the bus system 4 is configured to achieve connection communication between these components. In addition to including a data bus, the bus system 4 further includes a power bus, a control bus and a state signal bus. However, for the sake of clarity, the various buses are labeled as the bus system 4 in FIG. 7.

The memory 3 in the embodiments of the present disclosure is configured to store various types of data to support the operation of the electronic device. Examples of these data include any computer program that is operated on the electronic device.

It is understandable that, the memory 3 may be a volatile memory or a non-transitory memory, or may include both the volatile and non-transitory memories. The non-transitory memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM); and the magnetic surface memory may be a magnetic disk memory or a magnetic tape memory. The volatile memory may be a Random Access Memory (RAM), and is used as an external high-speed cache. It is exemplarily but unlimitedly described that, RAMs in various forms may be used, such as a Static RAM (SRAM), a Synchronous Static RAM (SSRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). The memory 3 in the embodiments of the present disclosure is intended to include, but not limited to, memories of these and any other proper types.

The method disclosed in the embodiments of the present disclosure may be applied to the processor 2, or implemented by the processor 2. The processor 2 may be an integrated circuit chip and has a signal processing capacity. During implementation, each step of the method may be completed by an integrated logical circuit of hardware in the processor 2 or an instruction in a software form. The above processor 2 may be a general processor, or may be a DSP, or other programmable logic devices, discrete gate or transistor logic devices, and discrete hardware components. The processor 2 may implement or execute each method, step and logical block diagram disclosed in the embodiments of the present disclosure. The general processor may be a microprocessor or any conventional processor. In combination with the method disclosed in the embodiments of the present disclosure, the steps may be directly implemented by a hardware processor, or may be performed by a combination of hardware and software modules in the decoding processor. The software modules may be located in a storage medium. The storage medium is located in the memory 3, and the processor 2 reads programs in the memory 3, and completes the steps of the method in combination with hardware.

The processor 2 implements corresponding processes in the methods of the embodiments of the present disclosure in response to that executing the program. For simplicity, elaborations are omitted herein.

In an exemplary embodiment, the embodiments of the present disclosure further provide a storage medium, i.e. a computer storage medium, which may be a non-transitory readable storage medium, for example, including the memory 3 storing the computer program. The computer program may be executed by the processor 2, so as to complete the above steps of the foregoing method for information fusion or the method for data communication. The non-transitory readable storage medium may be a memory such as an FRAM, an ROM, a PROM, an EPROM, an EEPROM, a Flash Memory, a magnetic surface storage, an optical disk, or a CD-ROM.

Those of ordinary skill in the art should know that all or part of the steps of the method embodiment may be implemented by related hardware instructed through a program, the program may be stored in a computer-readable storage medium, and the program is executed to execute the steps of the method embodiment. The storage medium which may be a volatile storage medium includes: a mobile storage device, an ROM, an RAM, and various media that can store program codes, such as a magnetic disk, or an optical disk.

Alternatively, in the embodiments of the present disclosure, if the integrated unit is implemented in the form of the software functional unit and sold or used as an independent product, it can be stored in the computer readable storage medium. Based on such an understanding, the technical solutions of the embodiments of the present disclosure substantially or parts making contributions to the related art may be embodied in form of a software product, and the computer software product is stored in a storage medium, including a plurality of instructions for causing an electronic device (which may be a personal computer, a server, a network device or the like) to execute all or part of the method in each embodiment of the present disclosure. The foregoing storage medium includes a portable storage device, an ROM, an RAM, and various media that can store program codes, such as a magnetic disk, or an optical disk.

The above are only the optional implementations of the embodiments of the application and not intended to limit the scope of protection of the embodiments of the present disclosure. Any variations or replacements apparent to those skilled in the art within the technical scope disclosed by the embodiments of the present disclosure shall fall within the scope of protection of the embodiments of the present disclosure. Therefore, the scope of protection of the embodiments of the present disclosure shall be subject to the scope of protection of the claims.

1. A method for information fusion, applied to a server in a distributed training system, comprising:
in response to that a communication triggering condition is met, acquiring a local parameter of each of workers in a distributed training system, wherein the communication triggering condition comprises all key nodes participating in a current round of training complete tasks of the current round of training;
selecting, from each of the workers, N key nodes participating in the next round of training, and fusing local parameters of the N key nodes to obtain a global parameter; and
sending the global parameter to each of the workers, and sending a training command to the key nodes to the key nodes execute tasks of the next round of training based on the global parameter.

2. The method for information fusion as claimed in claim 1, wherein all the key nodes participating in the current round of training completing the tasks of the current round of training comprises:
all the key nodes participating in the current round of training completing a preset number of iterative training processes.

3. The method for information fusion as claimed in claim 1, wherein selecting, from each of the workers, the N key nodes participating in the next round of training comprises:
calculating an average parameter of the local parameters of the key nodes, determining a deviation of the local parameter of each of the workers from the average parameter, and selecting N workers with the minimum deviation as the key nodes participating in the next round of training.

4. The method for information fusion as claimed in claim 3, wherein determining the deviation of the local parameter of each of the workers from the average parameter comprises:
sending the average parameter to each of the workers to each of the workers calculates the deviation of local parameter of each of the workers from the average parameter, and returning the deviation of local parameter of each of the workers from the average parameter to the server.

5. The method for information fusion as claimed in claim 1, further comprising:
dividing a training model into a plurality of training sub-models, and assigning the training sub-models to each of the workers.

6. The method for information fusion as claimed in claim 5, wherein dividing the training model into the plurality of training sub-models comprises:
dividing the training model into the plurality of training sub-models in a horizontal direction or a vertical direction.

7. The method for information fusion as claimed in claim 1, further comprising:
assigning a plurality of training samples to each of the workers to each of the workers executes an iterative training process based on the corresponding training samples.

8. The method for information fusion as claimed in claim 7, wherein assigning the plurality of training samples to each of the workers comprises:
assigning the plurality of training samples to each of the workers based on a sampling method, or splitting the plurality of training samples according to a data dimension, and assigning split training samples to each of the workers.

9. The method for information fusion as claimed in claim 8, wherein assigning the plurality of training samples to each of the workers based on the sampling method comprises:
assigning the plurality of training samples to each of the workers by means of put-back random sampling and/or local scrambling sampling; or
assigning the plurality of training samples to each of the workers by means of put-back random sampling and/or global scrambling sampling.

10. The method for information fusion as claimed in claim 8, wherein splitting the plurality of training samples according to the data dimension, and assigning split training samples to each of the workers comprises:
in response to that each training sample has a multi-dimensional attribute or feature, splitting the plurality of training samples according to different attributes, and assigning split sample subsets to the corresponding workers.

11. The method for information fusion as claimed in claim 1, wherein fusing the local parameters of the N key nodes to obtain the global parameter comprises:
calculating an average value of the local parameters of the N key nodes, and determining the average value as the global parameter.

12. A method for data communication, applied to a worker in a distributed training system, comprising:
in response to that a communication triggering condition is met, performing a compression operation on local parameters of each of the workers based on a preset compression algorithm, and transmitting the compressed local parameters to a server;
acquiring a global parameter sent by the server, wherein the global parameter is obtained by fusing, by the server, local parameters of N key nodes; and
in response to that receiving a training command sent by the server, executing corresponding training tasks based on the global parameter.

13. The method for data communication as claimed in claim 12, wherein the preset compression algorithm is:
$$C [ x ] = λ \cdot \frac{{‖ x ‖}_{2}}{d} \cdot sign ( x ) ;$$
wherein x is the local parameter, ∥x∥₂ is a L2 norm of x, sign(x) is the sign of x, d is a dimension of the local parameter, λ=|Σᵢ₌₁^{d}xᵢ|/d, xᵢ is an i-th dimension of x, and C[x] is the compressed local parameter.

14. The method for data communication as claimed in claim 12, further comprising:
acquiring an average parameter sent by the server, calculating a deviation of local parameters of each of the workers from the average parameter, and returning the deviation of local parameters of each of the workers from the average parameter to the server.

15. The method for data communication as claimed in claim 12, wherein,
in response to that the communication triggering condition is met, performing the compression operation on local parameters of each of the workers based on the preset compression algorithm, and transmitting the compressed local parameters to the server comprises: in response to that the key nodes participating in the current round of training complete tasks of the current round of training, performing the compression operation on local parameters of each of the workers based on the preset compression algorithm, and transmitting the compressed local parameters to the server;
acquiring the global parameter sent by the server comprises: in response to that the worker is selected as the key nodes participating in the next round of training, acquiring the global parameter sent by the server; and
in response to that receiving the training command sent by the server, executing the corresponding training tasks based on the global parameter comprises: in response to that receiving the training command sent by the server, executing tasks of the next round of training based on the global parameter.

16. The method for data communication as claimed in claim 12, further comprising:
acquiring part of a plurality of training sub-models, wherein the plurality of training sub-models are sub-models that are obtained by dividing a training model associated with the training tasks, and the plurality of training sub-models are assigned to each of the workers in the distributed training system; and/or
acquiring part of a plurality of training samples, wherein the plurality of training samples are training samples associated with the training tasks, the plurality of training samples are assigned to each of the workers, and each of the workers is used for executing an iterative training process based on the corresponding training samples.

17-19. (canceled)

20. A non-transitory computer-readable storage medium, having a computer program stored thereon, wherein when the computer program is executed by a processor, cause the processor to:
in response to that a communication triggering condition is met, acquire a local parameter of each of workers in a distributed training system, wherein the communication triggering condition comprises all key nodes participating in a current round of training complete tasks of the current round of training; select, from each of the workers, N key nodes participating in the next round of training, and fusing local parameters of the N key nodes to obtain a global parameter; and sending the global parameter to each of the workers, and sending a training command to the key nodes to the key nodes execute tasks of the next round of training based on the global parameter; or
in response to that a communication triggering condition is met, perform a compression operation on local parameters of each of the workers based on a preset compression algorithm, and transmitting the compressed local parameters to a server; acquire a global parameter sent by the server, wherein the global parameter is obtained by fusing, by the server, local parameters of N key nodes; and in response to that receiving a training command sent by the server, execute corresponding training tasks based on the global parameter.

21. The method for information fusion as claimed in claim 1, wherein each of workers is connected to the server in a two-way manner, and there is no direct connection between the workers.

22. The method for data communication as claimed in claim 16, wherein the sub-models are horizontally or vertically divided from the training model.

23. The method for data communication as claimed in claim 16, wherein the plurality of training samples are assigned based on a sampling method, or split according to a data dimension, and split training samples are assigned to each of the workers.
